(19) United States
(12) Patent Application Publication
(10) Pub. No.: US 2011/0059633 A1
(43) Pub. Date: Mar. 10, 2011

(54) Surface mount contact

(75) Inventors: Lien-Hsing CHEN, Taichung County (TW); Chih-Chi CHANG, Taichung County (TW); Hui-Hung HSIANG, Taichung County (TW)

(73) Assignee: POWER MATE TECHNOLOGY CO., LTD., Taichung (TW)

(21) Appl. No.: 12/588,778

(22) Filed: Oct. 28, 2009

(30) Foreign Application Priority Data
Sep. 7, 2009 (TW) 98216501

(51) Int. Cl. H01R 12/00

(52) U.S. Cl. 439/83; 439/78

(57) ABSTRACT

A surface mount contact includes a conducting pin having a shank, a first end at one end of the shank and second end at the other end of the shank, a first annular flange extending around the periphery of the shank and spaced between the first end and the second end and a second annular flange extending around the periphery of the shank and spaced between the second end and the first annular flange, and a thermoplastic connection member joined to the second end of the conducting pin and spaced from the second annular flange at a predetermined distance so that there is a room for the user to judge the connection status and quality between the conducting pin and the thermoplastic connection member during surface mounting, assuring bonding stability.

### BACKGROUND OF THE INVENTION

1. Field of the Invention

The present invention relates to conducting terminals and more particularly, to a surface mount contact for surface mounting application.

2. Description of the Related Art

Uneven PC board surface leveling and poor coplanar condition of electronic component pins may be encountered when bonding an electronic component to a PC board by means of a surface mounting technique. U.S. Pat. No. 6,700,079, as shown in FIG. 1, and U.S. Pat. No. 7,537,498, as shown in FIG. 2, disclosure measures to eliminate the aforesaid problems.

According to the design shown in FIG. 1, the surface mount contact comprises a pin 1, an insulator 2 surrounding the shaft of the pin 1, and a solder ball 3 wrapped about the bottom end of the pin 1 and connected to the bottom side of the insulator 2. Because of limited space between the solder ball 3 and the bottom end of the pin 1, the user cannot judge the distribution status and quality of the melted solder ball 3 around the pin 11 during surface bonding.

According to the design shown in FIG. 2, the surface mount contact comprises a conductive pin 4, a heat re-flowable bonding member 6 coupled to one end of the conductive pin 4 and conductive locator member 5 disposed around the conductive pin 4 between the two opposite ends of the conductive pin 4. The conductive locator member 5 serves as a locating member to limit the degree of travel of the conductive pin 4 within the bore of the PC board. When the heat re-flowable bonding member 6 is melted, the melted heat re-flowable bonding member 6 is freely distributed over the surface of the conductive pin 4 beneath the conductive locator member 5. However, because the size of the heat re-flowable bonding member 6 is not easy to control, it is difficult to control the distribution area of the melted heat re-flowable bonding member 6 around the conductive pin 4, resulting in bonding instability between the surface mount contact and the PC board.

### SUMMARY OF THE INVENTION

The present invention has been accomplished under the circumstances in view. It is the main object of the present invention to provide a surface mount contact, which enables the user to judge the solder distribution status and quality on the conducting pin.

It is another object of the present invention to provide a surface mount contact, which assures bonding stability.

To achieve these and other objects of the present invention, a surface mount contact comprises a surface mount contact includes a conducting pin having a shank, a first end at one end of the shank and second end at the other end of the shank, a first annular flange extending around the periphery of the shank and spaced between the first end and the second end and a second annular flange extending around the periphery of the shank and spaced between the second end and the first annular flange, and a thermoplastic connection member joined to the second end of the conducting pin and spaced from the second annular flange at a predetermined distance.

### BRIEF DESCRIPTION OF THE DRAWINGS

FIG. 1 is a schematic drawing of a surface mount contact according to the prior art.

FIG. 2 is a schematic drawing of another structure of surface mount contact according to the prior art.

FIG. 3 is a front view of a surface mount contact in accordance with the present invention.

FIG. 4 is a sectional view of the surface mount contact in accordance with the present invention.

FIG. 5 is a schematic drawing showing an application example of the surface mount contact in accordance with the present invention.

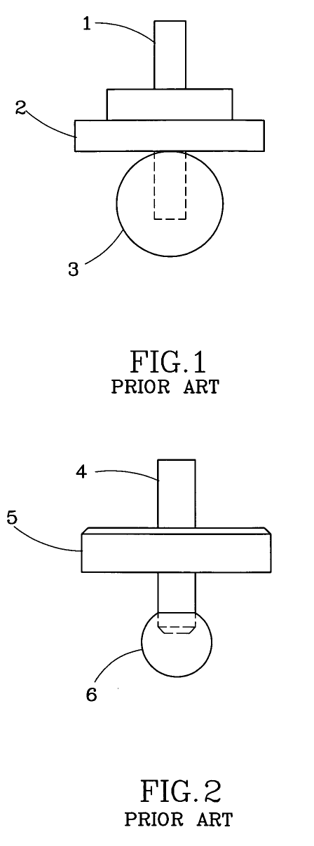

### DETAILED DESCRIPTION OF THE INVENTION

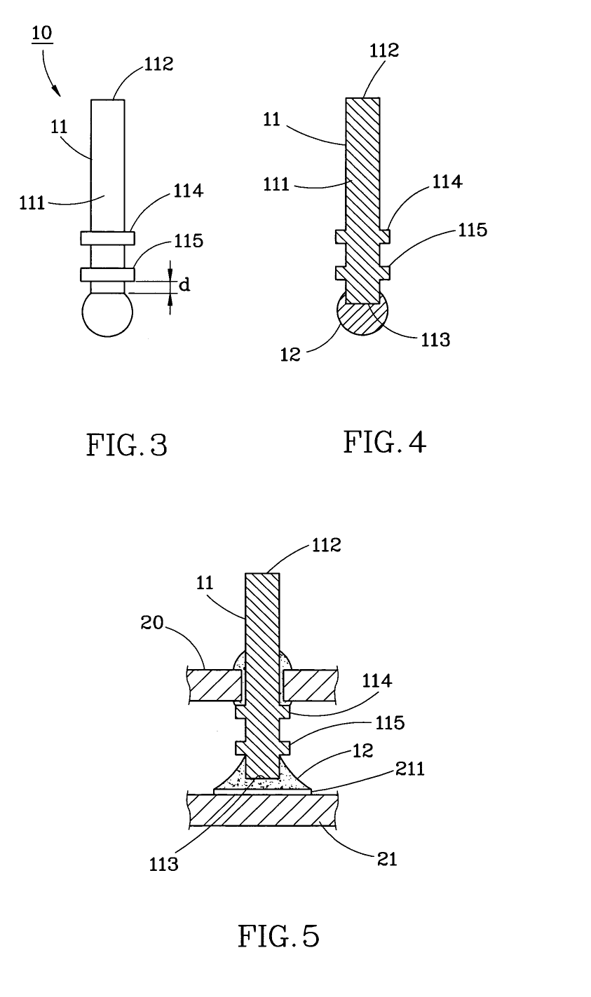

Referring to FIGS. 3 and 4, a surface mount contact 10 in accordance with the present invention is shown comprising a conducting pin 11 and a thermoplastic connection member 12.

The conducting pin 11 comprises a shank 111 having a first end 112 at its one end of the shank 111 and a second end 113 its other end, a first annular flange 114 extending around the periphery of the shank 111 and spaced between the first end 112 and the second end 113 and a second annular flange 115 extending around the periphery of the shank 111 and spaced between the second end 113 and the first annular flange 114. According to the present preferred embodiment, the shank 111, the first annular flange 114 and the second annular flange 115 are made from one same material in integrity by means of a single piece processing technique, for example, lathe processing technique. Further, the shank 111 can be configured to provide any cross section shape, such as circular, rectangular or oval shape.

The thermoplastic connection member 12 is joined to the second end 113 of the conducting pin 11 and kept away from the second annular flange 115 at a predetermined distance d. According to the present preferred embodiment, the thermoplastic connection member 12 is a spherical member prepared from a metal material, for example, solder ball.

After understanding of the structural features of the present invention, the application of the surface mount contact 10 is explained hereinafter. Fixedly fasten the surface mount contact 10 to an upper board (circuit board) 20 by means of bonding the part of the shank 111 of the conducting pin 11 between the first end 112 and the first annular flange 114 to the upper board (circuit board), and then melt the thermoplastic connection member 12 to bond the second end 113 of the conducting pin 11 to a solder pad 211 at a lower board (circuit board) 21, thereby fixing the relative position between the upper board 20 and the lower board 21. It is to be understood that the first annular flange 114 and the second annular flange 115 are formed around the periphery of the shank 111 at different elevations, the melted thermoplastic connection member 12 will be stopped by one side of the second annular flange 115 that is disposed close to the second end 113 during bonding, and there is a room for the user to judge the connection status and quality between the conducting pin 11 and the thermoplastic connection member 12 and to control the bonding area between the thermoplastic connection member 12 and the conducting pin 11 during surface mounting.

As stated above, the surface mount contact 10 of the present invention has the following advantages and features:

1. There is a room for the user to judge the connection status and quality between the conducting pin 11 and the thermoplastic connection member 12 during surface mounting. Based on the design of the first annular flange 114 and the second annular flange 115, there is a room for the user to judge the connection status and quality between the conducting pin 11 and the thermoplastic connection member 12 during surface mounting.

2. High bonding stability between the circuit board and the surface mount contact. Because the melted thermoplastic connection member 12 will be stopped by one side of the second annular flange 115 that is disposed close to the second end 113 during bonding, the bonding area between the thermoplastic connection member 12 and the conducting pin 11 is fixed, assuring a high level of bonding stability.

What is claimed is:

1. A surface mount contact, comprising:
a conducting pin, said conducting comprising a shank, said shank having a first end and a second end opposite to said fist end, a first annular flange extending around the periphery of said shank and spaced between said first end and said second end of said shank and a second annular flange extending around the periphery of said shank and spaced between said second end and said first annular flange; and
a thermoplastic connection member joined to the second end of said shank and spaced from said second annular flange at a predetermined distance.

2. The surface mount contact as claimed in claim 1, wherein said shank, said first annular flange and said second annular flange are made from one same material.

3. The surface mount contact as claimed in claim 2, wherein said shank, said first annular flange and said second annular flange are made in integrity by means of a single piece processing technique.

4. The surface mount contact as claimed in claim 1, wherein said shank has a circular cross section.

5. The surface mount contact as claimed in claim 1, wherein said thermoplastic connection member is prepared from a metal material.

6. The surface mount contact as claimed in claim 5, wherein said thermoplastic connection member has a spherical shape.

7. The surface mount contact as claimed in claim 6, wherein said thermoplastic connection member is a solder ball.
